(19) United States
(12) Patent Application Publication
(10) Pub. No.: US 2007/0199875 A1
(43) Pub. Date: Aug. 30, 2007

(54) PORTABLE WATER PURIFICATION SYSTEM

(76) Inventors: Ian M. Moorey, Kakabeka Falls, ON (CA); Andrew P. Moorey, Kakabeka Falls (CA)

Correspondence Address: ADE & COMPANY INC., 2157 Henderson Highway, WINNIPEG, MB, R2G1P9, CA

(21) Appl. No.: 11/538,261

(22) Filed: Oct. 3, 2006

Related U.S. Application Data
(60) Provisional application No. 60/776,936, filed on Feb. 28, 2006.

(51) Int. Cl. C02F 9/02; C02F 9/04

(52) U.S. Cl. 210/206; 210/238; 210/241; 210/257.1; 210/335; 210/416.3

(57) ABSTRACT

A portable water purification system comprises a micro particle filtration device and a portable batch treatment tank, receivable together within a portable container along with an intake and hoses for interconnection therebetween. A support structure is arranged to suspend plural filter housings of the micro particle filtration device therefrom in use, while being collapsible for storage in the container also. The batch treatment tank is expandable from a stored position within the container to a usable position plural times a volume of the container. A pump for pumping water from the intake, through the filtration device and into the batch treatment tank is provided on a portable frame separate from the container. The system is thus arranged to both mechanically remove cysts in the filtration device and chemically treat batches of water in the batch treatment tank for an elapsed period of time for purifying water from a variety of sources while remaining manually portable.

This application claims the benefit under 35 U.S.C. 119(e) of U.S. provisional application Ser. No. 60/776,936, filed Feb. 28, 2006.

### FIELD OF THE INVENTION

The present invention relates to a portable water purification system and more particularly relates to a water purification system including a micro filtration device for mechanical removal of cysts and the like, and in addition, a batch treatment tank for chemical batch treatment of the water for disinfection, in which the system is portable in a transportable container.

### BACKGROUND

It is known to provide water purification systems to improve the quality of water prior to drinking or for various other domestic uses. Water purification is commonly required in remote areas for temporary usage and accordingly transportable water purification systems are also known. An example of a required use for a water purification system includes emergency and/or post-disaster conditions where no electricity or technical support are typically available.

Various examples of water purifications systems are provided in U.S. Pat. Nos.: 6,616,839 to Peterson et al.; 6,764,595 to Halemba et al.; 5,972,216 to Acernese et al.: 6,936,176 to Greene III et al.; 4,659,460 to Muller et al.; 5,399,260 to Eldredge et al.; 6,464,884 to Gadgil; and 5,004,535 to Bosko et al.

In general many known water purification systems are too large to be manually transportable. Alternatively, smaller portable systems typically do not sufficiently purify the water to be fully safe for drinking, do not purify the water in sufficient volumes, or require unavailable electricity or unavailable technical support and are thus limited in their use. Furthermore, many water purification systems, large or small, commonly provide no form of residual disinfectant such as the addition of chlorine, or only provide minimal filtration of larger particles due to the limited number of mechanical filtering stages in known portable systems so that the known systems cannot ensure removal of all of the possible cysts, viruses and bacteria from a raw water supply.

Reverse osmosis is one known example of filtering water to remove micro particles including cysts and the like, however the volume of water produced is very limited as compared to the size of the unit and there is no residual disinfectant effect. When no disinfectant is added with no residual effect, the water can be easily re-contaminated if stored.

Some portable systems make use of a continuous flow of chlorine addition, however without a batch treatment tank which stores the water subsequent to the addition of chlorine, the chlorine or other disinfectant has to be added in much larger volumes to thoroughly mix with the water and disinfect the water sufficiently to be safe for drinking. The large addition of chlorine or other disinfectant is more costly and may have other detrimental effects to persons consuming the treated water.

### SUMMARY OF THE INVENTION

According to one aspect of the invention there is provided a portable water purification system comprising:

a portable container comprising a hollow interior surrounded by walls and an opening in the walls which is operable between an open position arranged to provide access to the hollow interior through the opening and a closed position in which the hollow interior is substantially enclosed by the walls;

an intake arranged for communication with a source of water;

a micro-particle filtration device having an inlet and an outlet and being arranged for communication of the inlet with the intake for mechanically filtering the water from the source of water;

a support structure arranged to support the micro-particle filtration device thereon, the support structure being operable between a stored position in which the support structure is receivable within the hollow interior of the container and a usable position in which the support structure is extended in relation to the stored position and is arranged to suspend the filtration device therefrom;

a portable batch treatment tank for communication with the outlet of the filtration device so as to be arranged for batch chemical treatment of the mechanically filtered water from the filtration device in the batch treatment tank; and

a pump arranged to pump the water from the intake, through the particle filtration device, and into the batch treatment tank.

By providing a system including both microfiltration for mechanically removing cysts and a batch treatment tank for chemically treating batches of water in storage for an elapsed period of time, water from various sources can be safely purified regardless of the presence of cysts, viruses or bacteria and the like in the raw water, with minimal chlorine addition being required and a resulting residual disinfectant effect being achieved. Providing such a system with both a microfiltration device and a batch treatment tank is particularly advantageous when provided in a manually transportable container so that persons can manually handle and transport the device into various remote areas where temporary supplies of purified drinking water are commonly required. Possible uses can include emergency or post-disaster situations where no electricity or technical support is available due to the simplicity of the present system which only requires fuel to operate internal combustion engine driven pumps to produce potable water.

Preferably the batch treatment tank is expandable from a stored position, in which the batch treatment tank is receivable within the hollow interior of the container, to a usable position, in which the batch treatment tank has a volume which is plural times a volume of the batch treatment tank in the stored position. The batch treatment tank may also have a volume which is plural times a volume of the container in the stored position.

In some embodiments, the support structure is mounted integrally on the container and suspends the filtration device therefrom for movement of the filtration device with the support structure between the stored position within the hollow interior and the usable position in which the filtration device is raised in relation to the stored position to extend through the opening.

The container may comprise rigid walls and a lid which is movable relative to the opening for operation between the open and closed positions. In this instance, the support structure may integrally mount the filtration device on the lid of the container such that the filtration device is movable with the lid between the closed position of the lid, in which the support structure is in the stored position, and the open of the lid, in which the support structure is in the usable position.

The lid may be supported spaced above the walls of the container in the open position by upright legs, the legs being collapsible and receivable within the hollow interior of the container in the closed position of the lid.

When the container is elongate in a longitudinal direction between opposed ends, the filtration device comprises a plurality of filters supported by the support structure integrally on the container at the opposing ends and defining a storage area therebetween.

The batch treatment tank may be arranged to be supported remotely and spaced apart from the container in use.

When the container comprises rigid walls and a lid and when there is provided an inlet conduit for connecting the intake to the inlet of the filtration device and an outlet conduit for connecting the outlet of the filtration device to the batch treatment tank, the inlet conduit and the outlet conduit are preferably supported to extend through the lid by respective ports integrally formed on the lid.

The filtration device may be operable within the hollow interior of the container with the lid in the closed position.

When gauges for monitoring a pressure condition of the filtration device are provided, the gauges may be integrally supported on the container and readable from an exterior of the container.

The intake preferably includes a micro filtration cover or micro filter thereon.

There may be provided a flow restrictor coupled in series with the inlet of the filtration device which prevents flow into the filtration device above a prescribed upper flow limit of the filtration device.

Preferably the portable container is manually portable and includes handles formed integrally thereon for gripping with a hand of a person.

There may be provided a distribution system including a distribution manifold, a distribution hose for connection from the batch treatment tank to the distribution manifold, and a plurality of distribution valves controlling distribution of water through the manifold in which the distribution system is receivable in the hollow interior of the container when the container is in the closed position.

When there is provided an inlet hose for communication between the intake and the filtration device, an outlet hose for communication between the filtration device and the batch treatment tank and a distribution hose for communication from the batch treatment tank to a distribution manifold, the intake, the hoses, the distribution manifold and the batch treatment tank are preferably receivable in a storage area defined between integrally supported filters of the filtration device within the hollow interior of the container in the closed position of the lid.

The filtration device may comprise an inlet manifold arranged for communication with the intake, an outlet manifold arranged for communication with the batch treatment tank, and a plurality of flow paths communicating between the inlet manifold and the outlet manifold in parallel with one another, each flow path comprising a plurality of filter members in series with one another.

Preferably, the filtration device comprises at least one disposable filter member and at least one reusable filter member, the filter members being supported in series with one another.

In some embodiments, the container comprises walls of flexible material arranged to support the filtration device and the support structure within the hollow interior of the container in the closed position.

The support structure may be arranged to support the filtration device remotely and spaced apart from the container in the usable position.

The filtration device may be non-electrical with the pump being driven by an internal combustion engine, supported on a transportable housing separate from the container.

When there is provided a plurality of batch treatment tanks, each tank is preferably expandable from a stored position, in which the batch treatment tank is receivable within the hollow interior of the container in the closed position of the lid, to a usable position, in which the batch treatment tank has a volume which is plural times a volume of the container.

When the filtration device comprises a plurality of filters coupled consecutively in series, each filter preferably restricts passage of smaller particles than a previous one of the filters.

The filtration device is preferably arranged to filter particles in stages down to 1 micron absolute.

One embodiment of the invention will now be described in conjunction with the accompanying drawings in which:

### BRIEF DESCRIPTION OF THE DRAWINGS

FIG. 1A is an exploded perspective view of the components of the water purification system and FIG. 1B is a partially assembled perspective view of the container.

FIG. 2 and FIG. 3 are respective front and rear elevational views of the container in a closed position.

FIG. 4 is a front elevational view in an open position of the container.

FIG. 5 is a schematic view of various components of the system shown connected in use.

FIG. 6 is a sectional view along the line 6-6 of FIG. 2,

FIG. 7 is a sectional view along the line 7-7 of FIG. 4.

FIG. 8 is a sectional view along the line 6-6 of FIG. 2 with the system in operation in a closed position of the container.

FIG. 9 is a sectional view along the line 7-7 of FIG. 4 in which the system is in operation in an open position of the container.

FIG. 10 is a bottom plan view of the filtration device supported integrally on the bottom of the lid of the container.

FIG. 11 is a side elevational view of the intake in use.

FIG. 12 is an exploded view of the intake.

FIG. 13 is a perspective view of the batch treatment tank.

FIG. 14 is a top plan view of the batch treatment tank in use.

FIG. 15 is a perspective view of the lid and the particle filtration device suspended thereon by the support structure according to a further embodiment of the present invention.

FIG. 16 is a bottom plan view of a lid supporting an alternate embodiment of the micro-particle filtration device.

FIG. 17 is a schematic illustration of a further embodiment of the portable water purification system.

FIG. 18 is a perspective view of the support structure and the micro-particle filtration device supported thereon according to the embodiment of FIG. 17.

FIGS. 19, 20 and 21 are respective side elevation, front elevational and top plan views of the support structure according to the embodiment of FIG. 17.

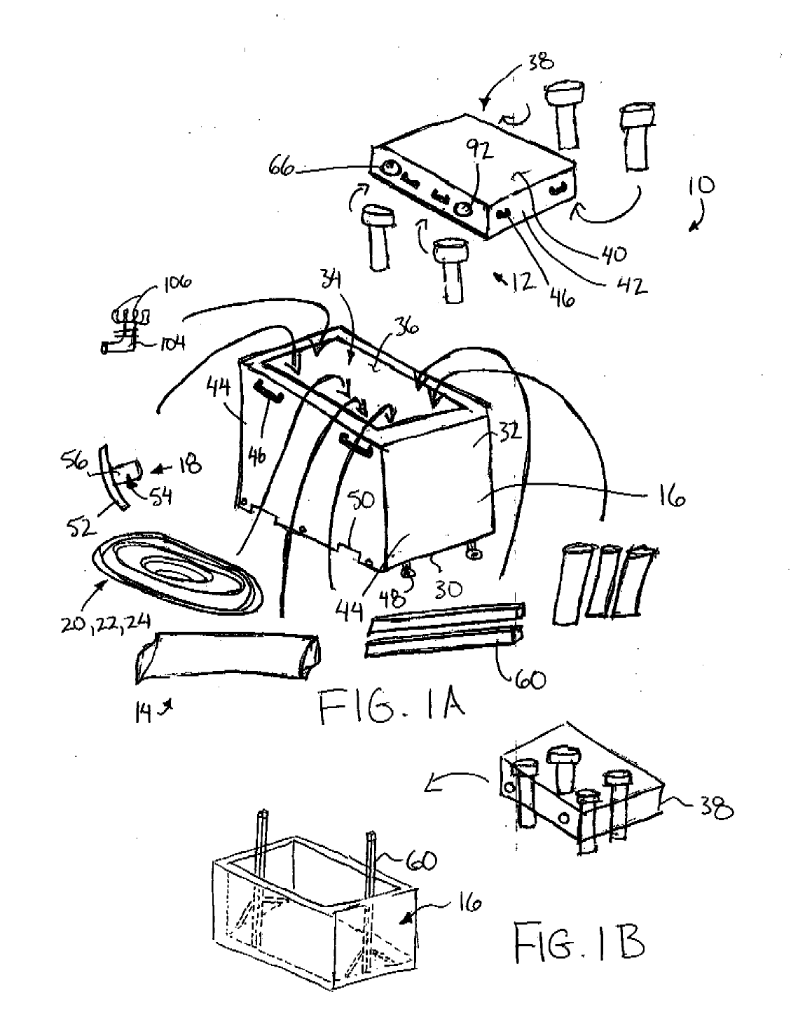

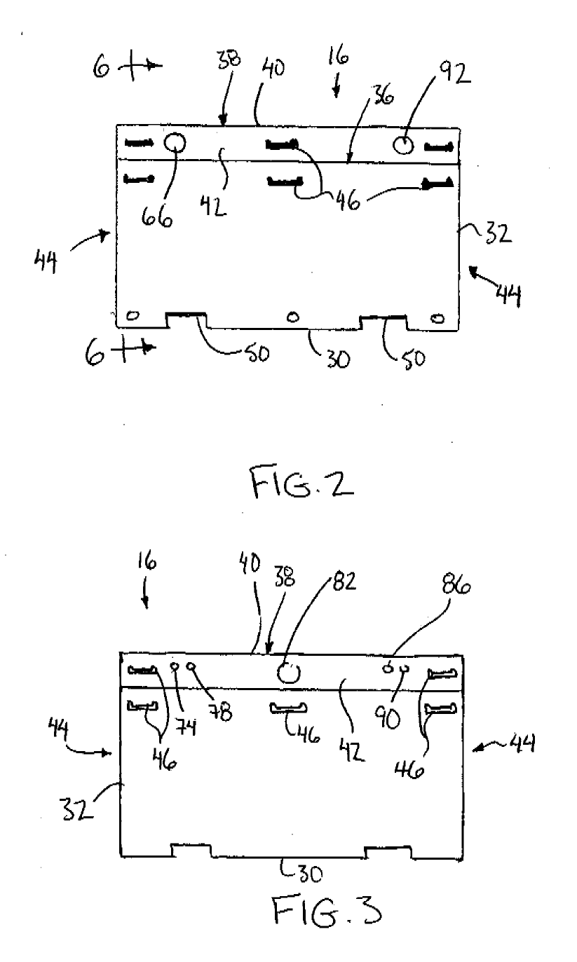

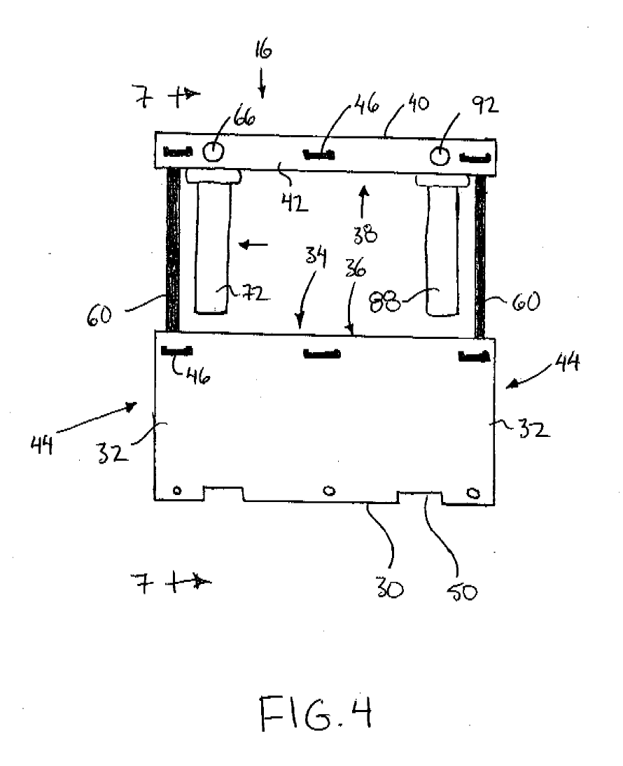

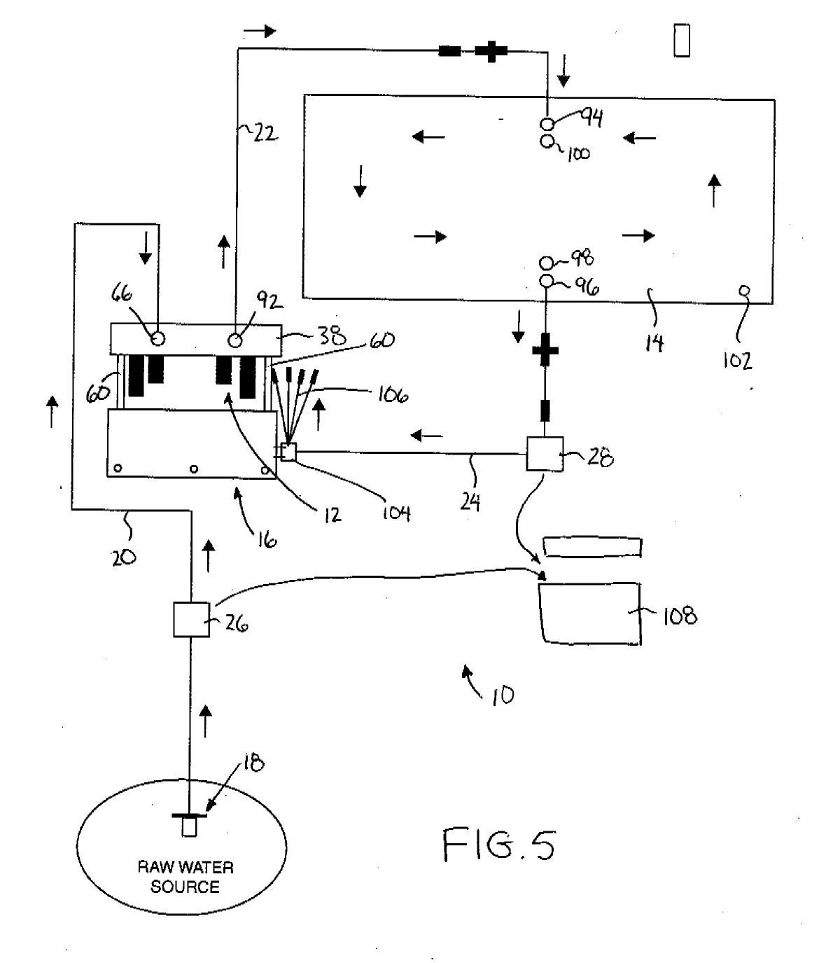

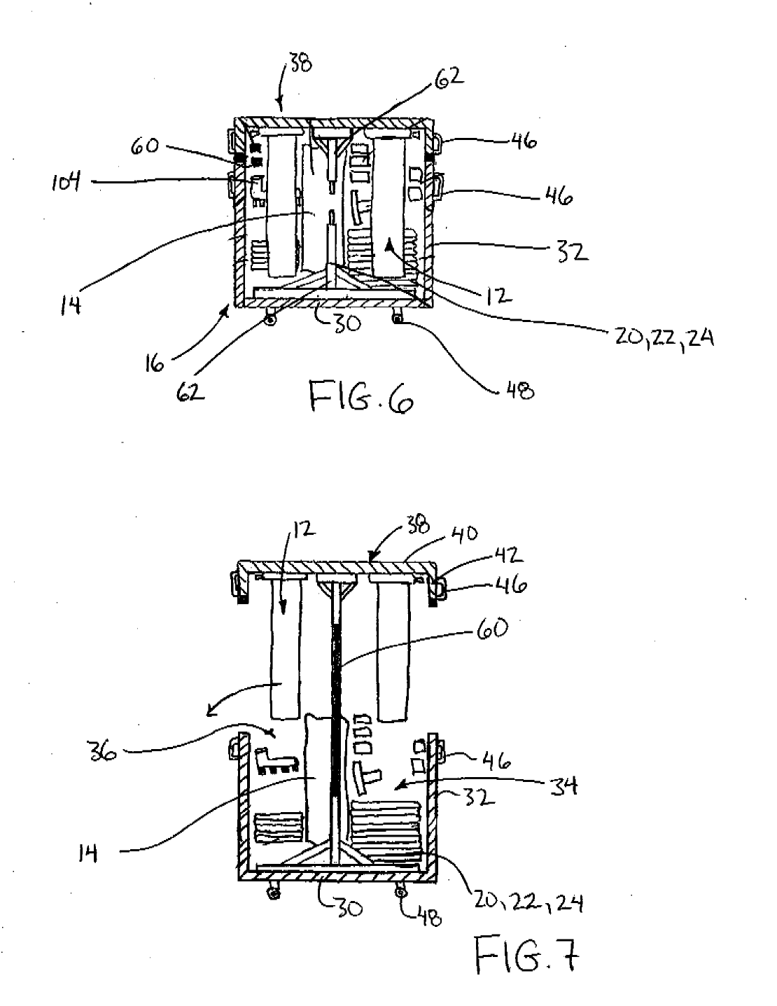

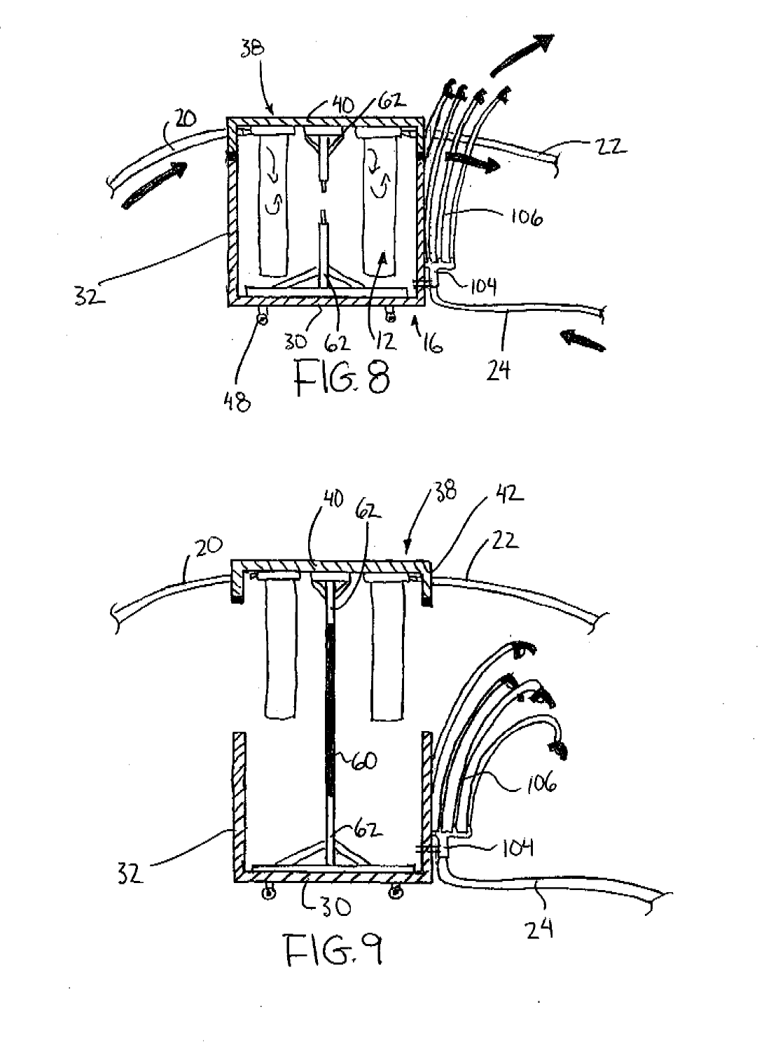

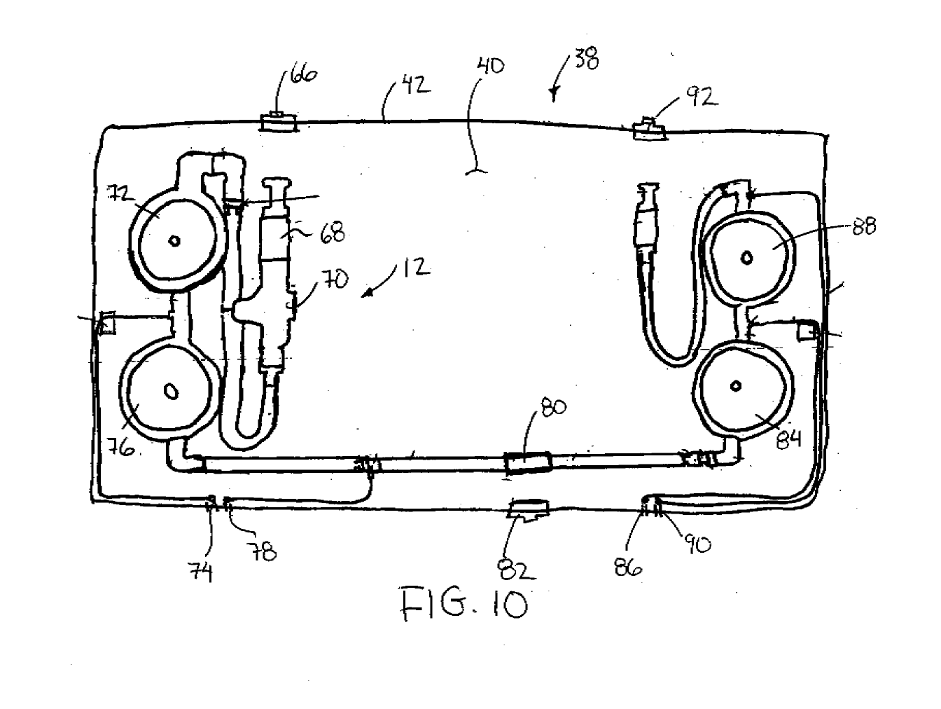

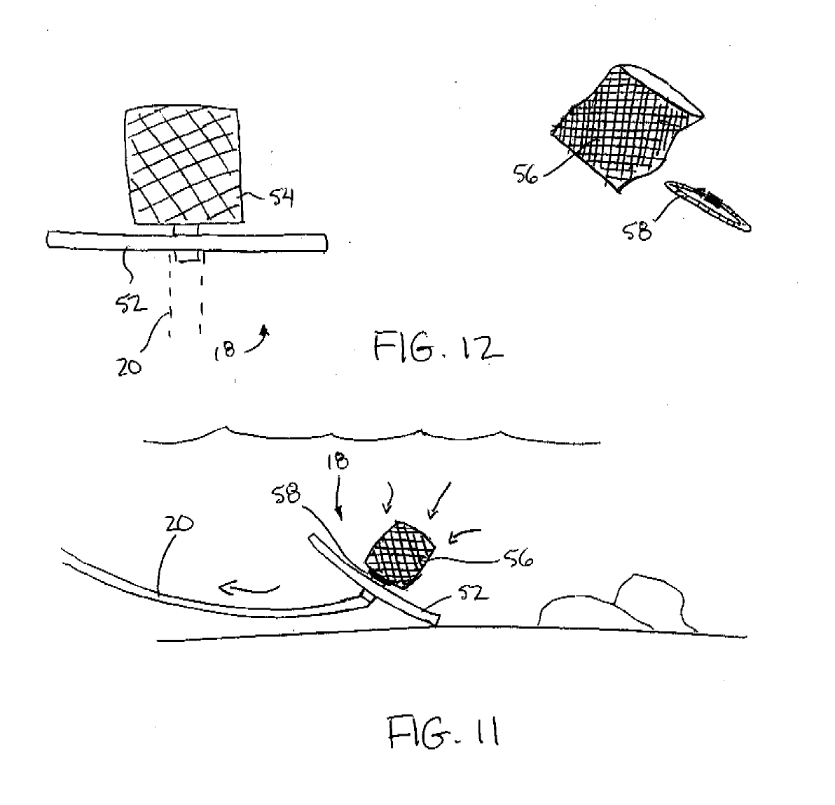

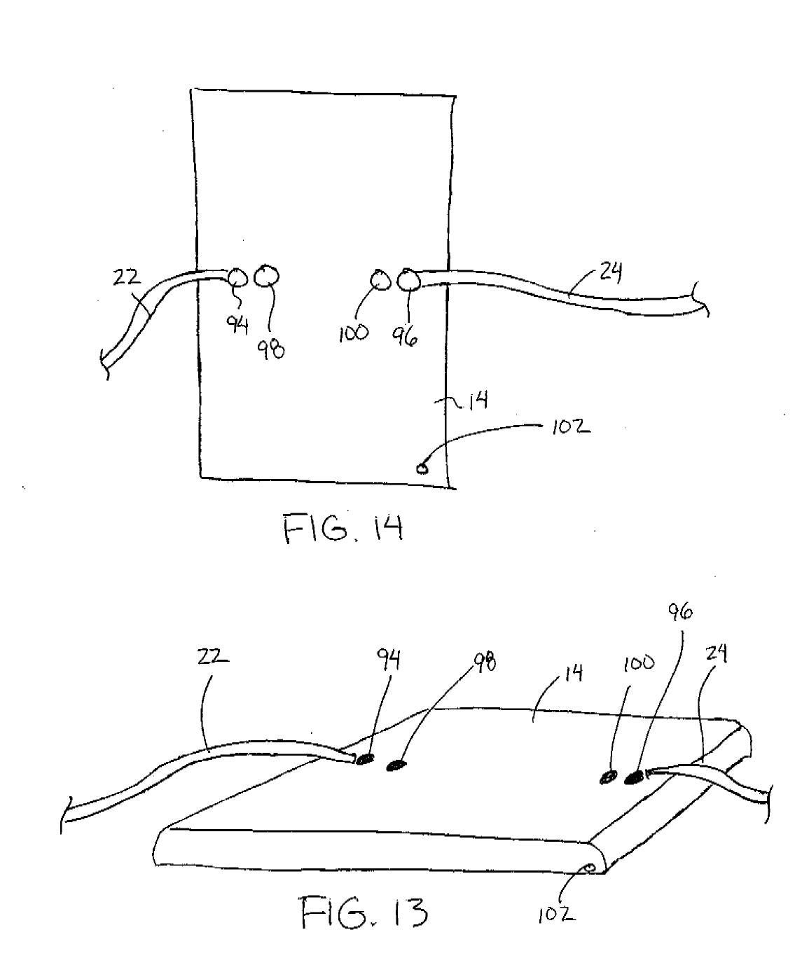

In the drawings like characters of reference indicate corresponding parts in the different figures.

### DETAILED DESCRIPTION

Referring to the accompanying figures there is illustrated a water purification system generally indicated by reference numeral 10. The system 10 is readily transportable and includes both a microparticle filtration device for mechanically removing microparticles from the water and a batch treatment tank 14 for batch chemical treatment to disinfect the water stored therein in batches for an elapsed period of time. For transport, the particle filtration device 12 and the batch treatment tank 14, and all required hoses, fittings, etc, are supported within a transportable container 16 which integrally supports the filtration device 12 in use and receives both the filtration device and the batch treatment tank 14 in storage and for transport.

The overall system includes an intake 18 for placement within a source of water 20 which may comprise untreated water sources including but not limited to lakes, rivers, creeks, streams, swamps, swimming pools, fire hydrants or tanker trucks and the like. An inlet hose 20 communicates between the intake 18 and the microparticle filtration device 12 at an inlet thereof for first mechanically filtering the water at the intake 18 then again at the filtration device 12. The filtration device 12 remains supported within the container 16 in use, but the batch treatment tank 14 is located remotely from the container in use as it is expandable to a size which is plural times that of the container for treating large batches of water therein. An outlet hose 22 is coupled from an outlet of the filtration device 12 into an inlet of the batch treatment tank 14.

The system further includes a distribution hose 24 which communicates from an outlet of the tank 14 to a suitable distribution area. A raw water pump 26 is coupled in series with the inlet hose 20 for drawing water through the intake 18 and into the inlet of the filtration device. A potable water pump 28 is provide in series with the distribution hose for pumping clean water form the tank 14 to the distributions area.

Turning now to the container 16 in further detail, the container comprises a military grade shipping container formed of plastic material which sealably encloses a hollow interior 34 so that the contents contained within the container are weatherproofed from the surrounding environment. The container includes a bottom wall 30 and side walls 32 which are rectangular and substantially surround and enclose the hollow interior 34 of the container. The container further includes a top opening 36 which fully spans the top side of the side walls 32 at the top of the container for access to the hollow interior.

A lid 28 is mounted on the walls 32 of the container for movement between a closed position fully spanning the top opening 36 and an open position in which the opening 36 is at least partially unobstructed for access to the hollow interior. The lid 38 comprises a top wall 40 which is also rectangular in shape and which supports a peripheral side flange 42 about a full periphery of the top wall 40 for extending downwardly to meet the respective side walls 32 of the container in the closed position of the lid. The container is elongate in a longitudinal direction between opposed ends 44 of the container.

The container 16 includes handles 46 formed integrally thereon about the side flange 42 of the lid and on the side walls 32. The handles are arranged to be gripped by two persons with their respective hands so that the overall container is manually portable as its typical weight in the stored position is only approximately three hundred pounds and therefore manageable by a few persons. To assist in portability, casters 48 are optionally mounted beneath the bottom wall 30. Two fork lift recess channels 50 are also formed in the bottom wall 30 to span laterally between the opposing front and rear sides of the container spaced apart from one another in the longitudinal direction between the opposed ends 44 by a suitable spacing for receiving forks of a fork lift.

Turning now to the intake 18, the intake comprises a base flange 52 which is annular and generally planar for surrounding and spanning radially outward from an inlet opening centrally located in the base flange. The diameter of the base flange is much greater than, in the order of plural times, a diameter of the inlet. The inlet hose 20 communicates with the inlet on a first side of the base flange 52 while a strainer body 54 communicates with the opposing side of the inlet. The strainer body 54 is centered about the inlet having a diameter which is plural times that of the inlet but which is smaller than that of the base flange while also having a length in an axial direction of the inlet which is also plural times a diameter of the inlet while being less than the diameter of the flange. The larger base flange keeps the suction area of the strainer body from directly contacting the bottom of a water source.

The strainer body 54 has a porous surface area which is many times the cross sectional area of the inlet for greatly reducing the suction force and flow rate across the surface area of the strainer in relation to the cross sectional area of the inlet. A reusable and/or easily changeable microfiltration member 56 fully covers the surface of the strainer body 54 to reduce the size of permissible particles passing into the inlet through the strainer body to particles less than 600 microns in diameter. A suitable clamp 58 retains the microfiltration member 56 in place on the strainer body.

With further reference to the container 16, the lid 38 is shown movable between the closed position spanning the opening and the open position in which the lid is suspended spaced above the walls to only partially obstruct the opening. The lid is supported in the open position as shown in FIGS. 4 and 7 by a pair of legs 60 which can be collapsed for displacement of the lid back into the closed position. The legs 60 are centered laterally and supported at opposed longitudinal ends 44 of the container 16.

A rigid bracket 62 is integrally mounted to a bottom side of the lid 38 at each opposed end 44 of the container and on the bottom wall 30 at each opposed end 44 for alignment with the respective bracket 62 on the lid. Each leg 60 thus comprises a rigid post for mating connection between a respective pair of the rigid brackets 62 in a vertical orientation. The ends of the post and the rigid bracket 62 include mating female and male connectors comprising a socket and a respective mating projection received therein. The legs 60 are slidably mated with the respective rigid bracket 62 for supporting the lid spaced above the side walls in the illustrated open position. To return to the closed position, the legs 60 are removed from the respective rigid brackets and placed to be extending in the longitudinal direction within the hollow interior of the container for storage.

Both top and bottom connections of the legs include a latch on each side of the leg to secure the connection. Each leg also includes a pin which inserts through the leg and then threads into the case structure to further secure and add rigidity to the connection.

The filtration device 12 includes a support structure in the form of clamping rings which selectively mount various components of the filtration device 12 integrally on the underside of the lid 38 of the container. The components of the filtration device are thus suspended from the lid and moveable with the lid from a stored position fully contained within the hollow of the container when the lid is closed and a usable position extending through the opening 36 in the container, spaced above the stored position in the open position of the lid. The filtration device 12 generally comprises a plurality of individual filters connected in series with one another such that each filter in sequence only permits passage of smaller particles than the previous filter, so that spread out over multiple stages the filtration device 12 is capable of filtering down to a level of one micron absolute without significant problems of the filters becoming too readily clogged.

The filtration device 12 includes various components coupled in series along a flow conduit thereof starting at an inlet port 66 which is integrally formed within the side flange 42 on the front side of the lid. The inlet port 66 defines an inlet conduit through the body of the lid for selective connection of the inlet hose 20 on the outer side of the lid to the remaining components of the filtration device within the hollow interior of the container. Within the interior of the container, the filtration device includes a flow restrictor 68 which restricts flow therethrough beyond an upper flow limit prescribed to the filtration device. Flow from the flow restrictor 68 is fed into a pressure restrictor 70 which reduces the system pressure to an acceptable level below a prescribed upper pressure limit of the system.

Once the flow and pressure of the incoming water have been regulated, the flow is directed into a first filter 72 comprising a bag filter rated at 200 microns to permit only particles of this size or smaller to be passed therethrough. A first pressure gauge 74 monitors pressure after the first filter 72. The first pressure gauge 74 is mounted integrally in the flange 42 at the rear side of the lid so as to be viewable from an exterior of the container.

After the first pressure gauge 74, flow is directed into a second filter 76 comprising a cartridge style filter to remove smaller size particles as the filter is rated at 100 microns to permit only particles of this size or smaller to be passed therethrough. The first pressure gauge 74 accordingly also monitors pressure to the inlet of the second filter 76.

A second pressure gauge 78 is also mounted in the rear side of the flange 42 of the lid so as to be viewed from the exterior. The second pressure gauge is coupled to the flow conduit at the outlet side of the second filter for monitoring pressure after the second filter. A flow meter 80 is coupled in series with the flow conduit downstream from the second pressure gauge in which the flow meter is accessible and viewable through an access port 82 also located in the flange 42 of the rear side of the lid. The flow meter is powered by a long life lithium battery and measures the flow of water moving through the system in either litres per minute or gallons per minute before the water is furthered along the flow conduit of the filtration device.

Subsequently the flow enters a third filter 84 comprising a multiple stage cartridge style filter to remove yet smaller size particles before continuing the flow of water along the flow conduit. The second pressure gauge 78 accordingly also monitors pressure to the inlet of the third filter 84.

The third filter includes four stages comprising a 50 micron filter element, a 25 micron filter element, a 10 micron filter element and subsequently a 5 micron filter element. Upon exiting the third filter 84, any particles greater than 5 microns in diameter have accordingly been removed from the flow of water. A third pressure gauge 86 is coupled to the flow conduit downstream from the third filter for monitoring the pressure after the third filter. The third pressure gauge is also mounted integrally in the flange 42 of the lid at the rear side so as be visible from the exterior of the container.

A fourth filter 88 is downstream from the third pressure gauge 86 and accordingly the third pressure gauge also monitors pressure to the inlet of the fourth filter. The fourth filter 88 comprises a 1 micron absolute filter designed to remove cyst sized particles from the water to effectively remove cysts such as Cryptosporidium and giardia before the water is forwarded to a fourth pressure gauge 90. The fourth pressure gauge 90 measures the pressure downstream from the fourth filter 88 and is also integrally mounted in the flange 42 at the rear side of the lid so as to readable form the exterior of the container.

The flow conduit is then directed to an outlet port 92 which is integrally formed in the lid in the flange 42 at the opposing front side of the container. The fourth pressure gauge 90 accordingly also monitors pressure at the outlet port 92+The outlet port 92 defines an outlet conduit through the body of the lid which selectively connects the outlet hose to the filtration device at an outer side of the container.

All of the filters noted above are selectively separable from the flow conduit of the filtration device for replacement and/or cleaning of the filter elements as required. The flow conduit is also releasably connected to the inlet and outlet ports respectively while the inlet and outlet ports are also selectively connectable to the respective hoses.

In the preferred embodiment, releasable cam lock type connections are provided at each selective separation of the flow conduit between the various components of the filtration device 12. The connections are threaded and not releasable between each filter, only the hose connection to the inlet or outlet have cam lock type connections.

The filters of the filtration device 12 are supported in pairs with the inlet port 66 and the first and second filters 72 and 76 being supported at one end of the container while the outlet port 92, the third filter 84 and the forth filter 88 are all supported at the longitudinally opposed end 44. A storage area is defined between the filter pairs at the opposed end for storing other components of the system therebetween in the closed position of the container.

The flow conduit communicates between all of the filters about a perimeter of the lid.

The gauges which are all supported integrally on the lid are all located on a common side of the body of the container along with the flow meter access port so that all of the operating components of the filtration device 12 can be monitored at once. The filters and flow conduit all remain integrally supported on the lid by the support structure as the lid is displaced between the open and closed positions and the inlet and outlet ports are configured for communicating through the body of the lid even when the lid is closed so that the filtration device 12 is fully operational in the closed position of the lid.

With reference to the batch treatment tank 14, the system is arranged for batch chemical treatment of water stored therein. The tank 14 comprises a large flexible bladder which can be fully collapsed and folded up for storage to be receivable within the storage area in the hollow interior of the container when the lid is closed while also being expandable in use to have a volume which is plural times the volume of the container. Multiple bladders may be provided for increasing the operating capacity of the system.

The batch treatment tank includes an inlet port 94 for connection to the outlet hose from the filtration device and an outlet port 96 for communication to the distribution hose of the distribution system. A testing port 98 is provided for permitting access to testing equipment into the batch treatment tank while an additional disinfectant injection port 100 is provided for receiving doses of a disinfectant, a chemical treatment, or both when opened. One or more drains 102 are also provide in the membrane of the bladder to assist in draining the tank prior to storage.

The distribution system generally comprises a manifold 104 having an inlet for connection to the distribution hose and a set of four or more outlets 106 having respective valves thereon for controlling the flow of treated water therethrough. The manifold 104 is storable within the storage area in the hollow interior of the container in the closed position, and in use can be supported on the exterior of the container 16. A plurality of auxiliary hoses may be connected to each of the outlets 106 of the manifold for use by multiple independent parties performing different tasks which require potable water. A check valve is provided in series with the distribution hose to prevent water back flowing into the batch treatment tank 14.

All of the hoses used in the system as noted above are food grade plastic and have different style connectors at respective ends thereof to ensure that each hose can only be connected to a designated one of the ports of the filtration device, the batch treatment tank or the distribution system. When in storage, the pumps are initially contained in a separate container 108 while the components of the distribution system, the collapsed batch treatment tank 14 and the intake, along with the respective hoses associated therewith are all received within the storage area between the filters at opposed ends 44 of the container, along with the legs which are collapsed with the lid in the closed position.

For use, the lid of the container 16 is initially unlatched from the side walls to permit the lid to be raised and supported spaced above the side walls by the legs 60 received in the respective brackets 62. While the filtration device remains integrally supported on the underside of the lid of the container by the respective supporting structure moveable with the lid, the remaining components are removed from the storage area within the hollow interior of the container for connection such that the intake is positioned within a source of water, the inlet hose communicates from the intake to the inlet port integrally formed in the lid of the container, the outlet hose is connected from the outlet port of the filtration device to the inlet of the bladder and the distribution hose is coupled from the outlet of the bladder to the manifold supported on the container body. Also the pumps are removed from the second container 108 so that the raw water pump is connected in series with the inlet hose and the potable water pump is connected in series with the distribution hose.

The pumps are each driven by respective internal combustion engines so fuel for the pumps is the only input energy required as there are no electrical components required to operate any of the remaining components of the system. By operating the raw water pump, water is collected from the source and forced through the filtration device to effectively mechanically filter the water down to one micron absolute which is fed into the inlet of the batch treatment tank 14. Solar powered electric pumps can optionally be used if desired.

Operation of the raw water pump continues until the bladder is at three quarters full capacity as monitored by the flow meter of the filtration device. At this stage disinfectant tablets in a dosage for a full bladder are added to the water within the bladder through the disinfectant inlet port on the batch treatment tank 14. Adding the disinfecting tablets when the tank 14 is only three quarters full ensures adequate circulation of the disinfectant as a result of the remaining water to be flowed into the bladder. Once the disinfectant has been added, the raw water pump is continued to operate until the tank is at full capacity as monitored by the flow meter.

The water within the batch treatment tank is then stored for approximately thirty minutes or as otherwise specified by the disinfectant being added until the water is bacteriologically safe and ready for distribution. No pumps are operated and no flow is permitted during the batch treatment in the tank 14.

Once the elapsed period of time has expired, the potable water pump is operated as demand of water from the distribution system requires it. Users can thus open any of the valves on the manifold to release water at which point potable water pump will operate to maintain pressure in the distribution hose.

When multiple tanks 14 are provided, upon completely filling one of the tanks after disinfectant has been added, a second tank may be immediately filled by connection to the outlet hose for overlapping the required batch treatment duration in the first tank. Water may then be already ready to be dispensed from the first batch treatment tank during the elapsed period of time for treatment in the second tank. Once the treatment period has expired on the second tank, water may instead be distributed from the second tank while the first tank is refilled on an ongoing cycle, Once the system is no longer required, all of the hoses are disconnected from the respective components and the storage tanks 14 are collapsed and folded so that all of the components are stored within the storage area in the hollow interior of the container 16 with the exception of the two pumps which are stored in the second container 108. The two containers can be easily handled manually by operators of the system for transport.

In summary, the system comprises a complete stand alone water treatment system using advanced microfiltration and chlorination technology in a compact, lightweight, flexible, reliable and complete package with a low capital and low operating cost. The system produces potable water without the use of electricity, gravity or challenging chemicals. The system makes use of technology to remove cysts such as Giardia and Cryptosporidium and a proven batch treatment tablet technology that eliminates a wide spectrum of micro-organisms, viruses, bacteria and waterborne disease such as e. Coli, faecal coliforms, Cholera, Typhoid and Dysentery. All of the components of the system are housed in two compact military grade shipping and operating modules and is capable of producing over 35,000 litres per day of drinking water with no objectionable chemical taste. Raw water is drawn through the strainer body of the intake and transferred to the microfiltration system using the fuel powered pump provided. The advanced microfiltration system removes cysts, sediment and turbidity from the water before it travels to the batch treatment tank for final treatment. The addition of specialized Sodium Dichloroisocyanurate, chlorine or other disinfectant tablets removes bacteria, viruses and waterborne disease from the water so that the water is now ready for distribution from the tank using a choice of hand or fuel powered pumps and a provided distribution system.

The system is a complete field ready water purification system which requires no on-site technical support for setup or operation. The system includes a dual process to produce bacteriologically safe water by making use of easy to use and safe to handle chlorine or other disinfectant based tablets. Liquid disinfectants can also be used. An on-site water testing and documentation program and equipment is provided for further safety. The system is completely reusable and storable while being easily transportable by land, sea or air in a system which can draw raw water from lakes, rivers, swimming pools, fire hydrants and the like.

The filtration device involves nine levels or stages of microfiltration with no pre-filtration required in some embodiments, while in other embodiments described herein involve only 5 levels or stages of filtration in the filtration device. In either instance the filters can be changed quickly and easily including washable and reusable pre-filters. Location of the pressure gauges are easy to read to monitor proper operation to ensure that substantially all silt, turbidity and sediment are removed to a level of one micron which exceeds NSF standard 53 for cyst sized particles. Subsequent use of a batch treatment tank including chlorine tablets, or other suitable equivalents, protects against recontamination during storage. An on-site chlorine testing and documentation kit which is included permits quality of the chlorine or other disinfectant levels within the water to be monitored.

The bladders forming the batch treatment tanks 14 each a volume of approximately 5,000 litres and require approximately two hours to fill. Once full the purification tablets are allowed to react within the bladder for 30 minutes at which point the water is ready to be distributed. Using the potable water pump, the entire bladder can be distributed in approximately 45 minutes. Once the bladder has been emptied the cycle is complete and a new batch can be started. The main system typically only includes one bladder. When using one bladder the system can produce 35,000 L per day. Alternatively, a second bladder may be provided in which case the system can produce 50,000 L when using both bladders.

The system can be easily setup with a minimum number of persons (typically 2 to open lid and only 1 to operate after that) and no technical expertise or support required as all of the hose connections are quick-connect connections requiring no tools. The initial setup stage involves locating the container on level ground and opening the primary container 16 by raising the lid to its open position spaced above the walls. All of the components are removed from the container with the appropriate connections being made so that raw water can be pumped from the source through the filtration device and into the batch treatment tank. Once the disinfectant has been added to the tank and the tank has been filled water is ready to be distributed within 30 minutes using the provided distribution system. Distribution may be effected using the potable water pump in series with the distribution hose, or alternatively a back-up foot pump may be provided for manually pumping water through the distribution system.

The water quality testing kit provided with the system permits every batch of water produced to be tested for residual levels of free chlorine. The treatment and test results can also be documented using the kit provided. Testing takes less than 60 seconds and can be done as often as required. A manual test kit includes a base chlorine test kit consisting of a thermometer, a sample bottle, free chlorine test strips, pH test strips, blank documentation reports and a clipboard. A digital test kit includes all of the components of the manual test kit plus a hand held digital meter capable of providing accurate measurements of pH and free chlorine without the use of test strips which can be hard to colour code.

An advanced testing module provides a verifiable, reliable and real time record of water quality parameters including temperature, pH, free chlorine and oxidation reduction potential. The module is self-contained, microprocessor based and battery powered and serves to indicate water quality. The module attaches directly to the batch treatment tank via a dedicated testing port providing constant data to the user. A data transfer adapter is also available to download historic data to a laptop or a personal computer.

When sanitizing water for consumption a strong oxidizer is added at appropriate levels. The oxidizer disrupts the cells of contaminants in the water being treated, rendering the cells dead or no longer a threat to health. As a result some of the oxidizer is spent. The remaining or residual oxidizer or sanitizer must be at appropriate levels to ensure appropriate remaining oxidizing potential, therefore when sanitizing water for consumption, residual oxidizer is important. If the oxidation reduction potential is too low, the water just processed might become re-contaminated, creating a hazard. The advanced testing module circuit detects the residual or remaining sanitizer and continually reports its oxidation reduction potential or oxidation power to provide the operator assurances that the water is fit to drink. The advanced testing module also measures pH. No training is required to operate the module and the module also operates without attendants. The module also maintains a log of pH, disinfectant and temperature and warns of recontamination. Ongoing changes in water quality are indicated to guard against contamination or unsafe water.

The overall system includes a number of important safety features. Different sizes and configurations of hoses are provided to ensure that a raw water hose is never mixed up with a treated or finished water hose. Flow restrictors and pressure limiters are included within the microfiltration device to ensure that the filter manufacturers specifications and guidelines are not exceeded regardless of pump size. A digital flow meter ensures that the water bladder is filled accurately for precision chlorine dosing. A water quality testing kit ensures that each and every batch of water produced is tested for residual chlorine levels and allows for accurate chlorine dosing. All hoses have a gasket sealed dust cover to ensure that the hoses stay clean and sanitary when in storage within the hollow interior of the container until use. In the assembled configuration, all hoses and connections can be secured in place with padlocks to prevent tampering. The entire microfiltration system can be operated in the closed position of the lid to provide security during challenging environmental or social conditions. All hoses and tanks are food grade. All gas or diesel pumps are stored in separate cases to prevent cross-contamination of fuel and or fuel odours to food grade hoses, tanks, etc.

When the lid of the container is closed, the container measures approximately 53 inches in the longitudinal direction, 29 inches high and 28.5 inches wide. The lid is moveable between the open and closed positions with the microfiltration integrally supported thereon for movement therewith. Support handles are provided on all sides of the container for ease of manually transporting the container. The container also includes a flush out drain for cleaning and two way fork lift pockets extending laterally from a front side to a rear side of the container. The auxiliary container for supporting the pumps measures approximately 2 feet by 2 feet by 2 feet and is arranged for secure stacking with the primary container 16. The containers are rotomolded in design and are provided with gasket seals on all openings and fittings penetrating the case. The latches which secured the lids to the walls of the container are twist type and lockable. A pressure relief valve is provided as well.

The overall system is extremely flexible and has a number of valuable options that can be added or can be custom designed. Additional tanks 14 ranging from 5,000 litres to 10,000 litres capacity can be added to increase production and storage capacity. Collapsible bottles ranging from 6 to 19 litres may also be provided for safe storage and transportation of the treated water. Additional filling lines may also be provided to increase capacity. Filter replacement packages are also provided for maintaining condition of the microfiltration device. Special application distribution modules in packages for shower, kitchen or decontamination facilities, for example, may be added on to the system 10. Special application filtration modules for unique water sources may also be provided.

Among the special modules a heavy metal module may be provided which will remove and/or reduce a number of contaminates such as mercury, lead, VOC's, pesticides, herbicides, etc that may be present in some high risk water sources. Long term consumption of heavy metals has been linked with a number of health concerns.

A hydrocarbon and synthetic oil module may also be provided which removes all traditional and synthetic oil contamination down to non-detectable levels. Shorter term consumption of traditional or synthetic oils can cause various unpleasant conditions to users to the water. While most fresh water sources are not contaminated with traditional or synthetic oils, emergency situations may dictate the use of city harbours or rivers that may indeed be contaminated. Basic hydrocarbon removal can now be done by switching out one of the disposable filters within the system that only filters out particles with a special filter capable of removing both particles and hydrocarbons.

The system 10 produces potable drinking water without electricity, gravity, challenging chemicals or technical support. The system is extremely compact, portable and lightweight, easily transportable by truck, boat, helicopter or aircraft. No electricity or gravity is required. The system is a complete field ready water purification system in which absolutely everything is included. No on-site technical support is required to setup or operate the system. The system involves a dual process cyst removal and virus and bacteria inactivation using easy to use and safe to handle chlorine based tablets. Easy to use on-site testing and documentation is also provided. The system is shipped in military grade shipping and storage modules which are easily transportable by land, sea or air. Gas or diesel pumps are stored separately to prevent fuel cross contamination.

Because the system 10 does not require electricity to operate, it is lighter with fewer parts prone to failure in the field. Small but reliable gas or diesel powered pumps are used instead of electric pumps. Many electric pumps supplied with other systems are not designed to move water up elevations or over distances. The system is available with optional pumps of varying size and power to meet individual needs.

The system is shipped within compact, lightweight, military grade cases that act as both storage and operating modules. Many cases supplied with other systems are extremely heavy, awkward, bulky, expensive to ship and hard to move around. The containers of the current system 10 are completely sealed with air tight gaskets, pressure relief valves, and also meet international insect control standards that many wooden cases do not.

The system 10, according to preferred embodiments, incorporates a 5 stage microfiltration system that is designed to work in challenging, real life conditions. Most 2 or 3 stage systems are just not practical when the water source is the least bit turbid. When the filters of the system 10 do not need to be changed, inexpensive filter stages are there to protect the more expensive and important ones.

The system 10 uses reliable chlorine technology to eliminate bacteria, viruses and other waterborne diseases and to leave a residual level of free chlorine to protect the treated water from recontamination during storage, transportation and distribution. Reverse osmosis and UV light systems do not provide this protection. Recontamination of treated water is a real threat, especially in the challenging conditions that the Can Purees WPS is designed to be used.

The system 10 offers incredible value when compared with reverse osmosis or UV light-based systems. Factors to consider include: low capital investment; a typical chemical treatment cost of approximately one cent per 20 L (5 US Gal.); inexpensive pre-filters to protect more expensive filters to reduce operating costs; the system 10 being one of the lightest systems available which also saves shipping costs; the system 10 does not require technical support which can often cost more than the systems themselves; and the system 10 is built to operate under rugged conditions and to be used and re-deployed over and over again reducing the capital investment each and every time it is used.

The system 10 includes a number of safety features that most systems overlook including: flow restrictors and pressure limiters to ensure that it is impossible to accidentally overload the microfiltration system by using a pump that is too large; devices, such as a digital flow meter, to ensure the water bladder is not over or under filled and to allow for precision chlorine dosing; check valves and pressure relief valves included to protect the investment in pumps and prevent downtime in the field.

The system 10 offers 3 different field testing programs. These programs provide the user with the ability to test and document each and every batch of water produced. Reverse osmosis and UV light systems simply do not provide this valuable feature.

The system 10 uses microflitration and chemical treatment. Chlorination without microfiltration is simply not effective. The process of chlorination to kill micro-organisms, as discussed by the World Health Organization (WHO), reads “. . . the process only works, however, if the chlorine comes into direct contact with the organisms. If the water contains silt, the bacteria can hide inside it and not be reached by the chlorine.”

The system 10 provides absolutely everything required to produce, store and distribute water, free of cysts bacteria and viruses. No other system provides such a complete and comprehensive package including test kits, spare parts, hose repair kits, bladder repair kits (that do not require heat sources) and much more. Optional equipment includes collapsible water bottles for storage and distribution from 6 L -20 L, additional water bladders from 5,000 to 10,000 L for extra versatility, a multi-line distribution system allowing an unlimited amount of users to fill bottles at once, and much more.

The system 10 is a complete, turn-key water purification system capable of producing over 50,000 L per day of potable water in emergency situations. The system 10 ensures the mechanical removal of cysts and the inactivation of viruses and bacteria through chemical disinfection. The method of chemical disinfection also provides a means of protecting the produced water from recontamination during storage, transportation and distribution to end users.

The system 10 contains all equipment, components and manuals required to treat, store and distribute potable water using fresh water sources such as lakes, rivers and streams. The system 10 operates without the need for electricity or electrical generators and/or gravity. The system is lightweight and compact in nature and easily transportable by no more than 4 people via pickup truck, helicopter, small aircraft or small watercraft.

The system 10 is operable by any adult with basic mechanical aptitude and does not require any outside technical expertise or support to operate, repair or maintain. The system 10 includes all components and systems required to produce potable water, store up to 10,000 L of said water, and finally bottle said water into transportable containers at a minimum rate of 29 gpm. The system 10 also includes a complete spare parts kit and repair kit capable of allowing field repairs to all systems including pumps, treatment systems, storage systems and distribution systems.

The system 10 also includes a water quality testing kit capable of testing for pH, temperature, free chlorine and/or ORP with data log and download capability.

The system 10 is contained in 2 compact, waterproof, durable, military specification storage and transportation cases. The system is also adaptable to customer provided storage and transportation solutions to match current operating guidelines and/or systems.

The microfiltration device is designed to mechanically filter raw water drawn from the raw water source. This filtration removes turbidity, silt, sediment and organic matter necessary for effective water disinfection while also removing cysts such as Giardia and Cryptosporidium which cannot be effectively inactivated by chemical disinfection and which can cause serious gastrointestinal illness. The microfiltration device can also be used to remove hydrocarbons such as oil and gasoline by simply switching out one specific filter. Hydrocarbons are often present in flood conditions where vehicles have been submerged or in some municipal harbors.

The system 10 is designed to be operated in an included storage/transportation case in order to provide necessary protection from challenging environmental and social conditions. The system does not have to be removed from its protection storageltransportation case and exposed to the elements in order to be operated.

The system includes a S stage food grade microfiltration system capable of producing 12 gpm of filtered water. The pre-filters are washeable to extend filter life and the system is capable of 1 micron absolute filtration, that exceeds the 3 log 99.9 removal requirement described in NSF Standard 53. The system 10 is capable of basic hydrocarbon removal without additional assets at a rate of 12 gpm and is capable of filtering the following water conditions: flooded surface water with high levels of turbidity and organic debris. The system 10 is complete with a pressure gage system between all primary filters to measure to a detail of no less than 2 lbs per square inch increments. The system 10 is complete with safety devices to prevent accidental pressure and/or flow overload resulting from substitute pumps, fire hydrants, etc.

The system 10 is pressure tested before shipment to 60 PSI. The system 10 is also: complete with all tools required to perform filter changes, complete with a sealed system, long life 3 volt lithium battery powered flow meter operable in Imperial or metric, pre-calibrated, including reset feature, flow rate per minute, total flow rate, and non-resettable cumulative flow history, accuracy +/−3%, readability +/−0.1%; operable within an impact resistant protective storage/transportation case without removal from said case; contained within mil-spec storage/transportation case no greater than 53×29×29″ including 2 way fork lift access, 4 side carry handles, emergency drains, waterproof seals and pressure relief valve for air transport, weighing approximately 375 lbs along with an additional 50 lbs gas pump module, weight including the mircofiltration system and the container; adaptable to customer supplied case system; and complete with spare parts kit and field repair kit.

The batch treatment tank 14 which comprises a collapsible bladder, is an integral part of the system. The collapsible bladder is a custom designed closed system, collapsible storage tank. A closed system storage tank protects the water inside from outside contaminants whereas an open top onion style tank does not. Each bladder contains custom fittings allowing for separate inlets, outlets, testing ports, drains, etc. Each bladder contains safety and isolation devices which protect the water during storage from back flow, accidental raw water inflow, etc. Each bladder includes a ground sheet for added protection when operating on rough surfaces. It is critical of course that the bladder be made of food grade materials. The tank 14 comprises a standard 5,000 L collapsible food grade bladder (non-mil-spec) (for daily production 35,000 L) and includes the following food grade, camlock fittings, 1×2″ inlet, 1×2″ outlet, 1×2″ testing port, 2″ tablet port and 2×2″ drains. An optional second 5,000 L collapsible bladder, duplicate of the above, increases daily production to 50,000 L. The optional second bladder requires an additional storage/transportation case. An optional mil-spec bladder can be made available as well as an optional 10,000 L bladder with same fittings available in either regular or mil-spec food grade materials. Each bladder is complete with a ground sheet and includes safety and isolation devices to isolate water during storage and distribution.

After microfiltration, the water is free of cysts but still requires disinfection to inactivate viruses, bacteria and other waterborne illness including E-coli, fecal coliforms, typhoid, cholera, etc. The system's disinfection tablets produce measurable amounts of free chlorine, are safe to handle, classified as non-hazardous, are safe for long term use (vs. iodine disinfection), and have been proven through numerous field trials.

The gas powered centrifigual pumps of the system 10 are reliable, easy to use, compact and lightweight in nature. The pumps are critical in moving both raw water and finished, potable water throughout the system. The pumps include a pump protection system that will protect the pump in the event of a sudden blockage of the water flowing from the pump. This can happen if a vehicle drives over a hose line, a kink develops in a hose or a distribution hose or a valve is shut off without accompanying pump shut off. Each pump can be clearly marked and fitted with different fittings in order to prevent the raw water pump and the potable water pump from being accidentally switched with each other. The pumps include the following specifications: 29 GPM gas powered centrifigual pump with industrial use 2 year warranty; dry weight: 15 lbs. per pump; complete with pump protection system—check valve, pressure relief device to prevent pump damage; 2 units, each to include different fittings and marked for raw and treated water only respectively: include 10 and 20 L mil-spec portable fuel containers with gravity flow fuel feed system; include field repair kits including: spark plugs, air filter, fuel filter, etc; complete with mil-spec storage/transportation case including custom cut foam protection lining.

The system 10 makes use of specific hoses for specific purposes. Each hose is food grade rated and of the highest quality. The overall hose design ensures that hose diameters and fittings are different to ensure that raw water hoses and potable water hoses are never mixed up. Each hose is also labeled with waterproof, durable labels that include the hose label and set up instructions.

All hoses are food grade rated. The system 10 includes: 1 suction hose 1″×25″, suction rated, 1 supply hose. 1″×100″, lay flat, 1 supply hose, ¾″×50′, hard line, kink resistant, complete with shut off valve, 1 supply hose, 1″×50′ hard line, kink resistant, complete with shut off valve and check valve, 1 supply hose, 1″×50′, hard line, kink resistant, complete with shut off valve and check valve, and 4 distribution hoses, ½″×10′, complete with spring loaded nozzles, without lock open device. The overall hose design includes a safety system ensuring non-compatibility with incorrect system hose placement. Each hose is pressure tested to 60 PSI. Each hose is complete with PVC camlock fittings (excluding distribution hoses complete with brass quick connect fittings). Each hose includes gasket seal dust covers excluding the brass fittings.

The distribution manifold is designed to split the supply of potable water being pumped out of the bladder into 4 sub lines fitted with trigger style, spring loaded fittings. These fittings allow a minimum of 4 users at a time to distribute water, generally into collapsible 19 L optional containers. The distribution manifold quickly and easily attaches to the microfiltration system case which also provides hangers for each of the 4 distribution hoses. Construction of the manifold is brass and PVC. Fittings are brass quick connect type The manifold is complete with an attachment bracket designed to connect to the container 16 or to a customer supplied case. The manifold comprises a brass, 4 head splitter including individual shut off valves to split a supply line from the bladder into 4 individual distribution hoses.

The system 10 includes a complete spare parts kit and field repair kit having 2 of any and all required gaskets 1 of any and all gasket lubrication, 1 thread sealing tape, thread sealing liquid, 1 pressure gage, 2 clamps for each size of hose supplied, 1 pump repair kit, 2 hose repair menders for each size applicable hose, 1 hose protective/repair sleeve and 1 pressure gage with a 5 foot spare connecting line.

The system 10 is a complete turn-key water treatment system that requires no outside components or support (except gasoline or diesel fuel for pumps). The system 10 removes both cysts (by mechanical filtration) and bacteria and viruses (by batch treatment chlorination). The system 10 includes water filtration, purification, storage and distribution in one package, notably such a small package of only 2 cases. The system 10 is integral to its shipping/storage case. Most systems have to be removed from the shipping/storage case to be set up and operated.

The system 10 uses a batch treatment concept where water is filtered and transferred to a storage tank (bladder) for treatment with chlorine (requires contact time) and then is distributed using included pumps.

The distribution system either supplies water to a distribution manifold to 4 or more separate hoses with nozzles for distribution into individual containers or transfers water directly to a shower or kitchen trailer.

The intake of the system 10 is unique in that there is provided a micro filtration member spanning the strainer body. The membrane is a plastic mesh, 600 microns that is adapted from a traditional replacement bag filter to immensely improve the ability of the strainer body to filter out particles.

The addition of a pump protection system to the small, compact gas powered pumps is an important improvement over the prior art pump configurations. Conventional pumps are not protected from sudden stoppages such as a truck driving onto a hose and stopping the flow of water, or someone shutting off the nozzle while the pump is running.

The filtration device of the system 10 involves a 9 stage microfiltration system in a compact and unique package including a 600 micron filter stage right on intake strainer, one 4 layer filter stage, and additional filters. The whole system can filter challenging water (flooded river) and continue to operate. Prior art systems commonly only provide 2 filters, 2 stages of filtration and a non-graduated filter system, for example raw water fed into a 5 micron filter which causes rapid filter plugging. Alternatively, the system 10 takes raw water and sends it through a 600 micron filter, a 200 micron filter, a 100 micron filter, a four stage 50 micron/25 micron/ 10 micron /5 micron filter and finally a 1 micron absolute filter. Additional filters can be added to remove oil and gasoline down to non-detectable levels.

As described above, the system 10 is a complete, turn-key water purification system capable of producing 35,000 to 50,000 L of potable water in emergency situations. The system 10 produces potable water by removing parasitic cysts through mechanical filtration and inactivating viruses and bacteria through disinfection via chlorination. The method of chemical disinfection also provides residual levels of free chlorine to protect the finished water from recontamination during storage, transportation and distribution to end users. The system 10 contains all equipment, components and manuals required to treat, store and distribute potable water using fresh water sources such as lakes, rivers and streams. The system 10 operates without the need for electricity, electrical generators and/or gravity. The system is lightweight and compact in nature and easily transportable by no more than 4 people via pickup truck, helicopter, small aircraft or small watercraft.

The system 10 is operable by any adult with basic mechanical aptitude and does not require any outside technical expertise or support to operate, repair or maintain. The system 10 includes all components and systems required to produce potable water, store this water, and finally, dispense this water into transportable containers at a minimum rate of 29 gpm. Optional components are available to supply kitchen, shower or decontamination facilities. The system 10 also includes a complete spare parts and repair kit allowing field repairs to all systems including pumps, water bladders and distribution systems.

The system 10 also includes a water quality testing kit capable of testing for pH, temperature, and free chlorine. A variety of optional, advanced kits are also available to test for free chlorine, total chlorine, pH and/or ORP with data log capability.

The system is contained in 2 compact, waterproof, durable, mil-spec storage and transportation cases. The system is also adaptable to customer provided storage and transportation solutions. The cases are rugged, durable, and designed to mil-specs, to act as shipping, storage and operating housings. For instance, the micro-filtration system is not just stored within the first case, it is integral supported in the first case. The first case or container 16 includes: 2-way fork lift pockets, 4-way carry handles with high and low positions; waterproof gasket seals; a breather valve; lockable latches; a stackable design; mil-spec MIL-STD-810, MIL-0150 standards; optional casters; and does not rust, rot, corrode or require insect certification like wood.

The micro-filtration system is designed to mechanically filter water drawn from the raw water source to 1 micron absolute. Filtration to this degree removes parasitic cysts such as Giardia and Cryptospohdium while also removing turbidity, silt, sediment and organic matter necessary for effective water disinfection using chlorination. The filtration system is integral to the shipping/storage case itself and can be operated in either the open or closed position. Operating the system in the closed position is ideal during challenging environmental or social conditions.

The micro-filtration system can also be used to remove hydrocarbons such as oil and gasoline by simply switching out one specific filter. Hydrocarbons are often present in flood conditions where vehicles have been submerged or in some municipal harbors. In the preferred embodiment, the micro-filtration system has 5 stages, including 1 micron absolute technology capable of producing 12 gpm of water that exceeds the 3 log 99.9 removal requirements described in NSF Standard 53, The system has pre-fitters that are washable for extended filter life; is designed to work with challenging water sources such as flooded rivers with high levels of turbidity and organic debris, etc; is complete with a pressure gauge system to measure the differential pressure between filter housings which is waterproof, visible from the exterior, has readings to 2 liter per square inch detail; is complete with advanced safety devices to prevent accidental pressure and/or volume overload resulting from substitute pumps, fire hydrants, etc; is pressure tested before shipment to 60 PSI; is complete with all tools required to perform filter changes; is complete with a flow meter sealed system with a long life, 3 volt lithium battery powered system operable in imperial or metric, pre-calibrated, including reset feature, flow rate per minute, total flow rate, and cumulative flow history, with accuracy to +/−3%, readability to +/−0.1% and visible to the exterior; is contained within and integral to a compact mil-spec roto-molded storage, transportation case; is adaptable to customer supplied case system upon request; and is complete with a spare parts kit and a field repair kit.

After micro-filtration, the water is free of cysts but still requires disinfection to inactivate viruses, bacteria and other waterborne illness including E-coli, fecal coliforms, typhoid, cholera, etc. The disinfection tablets of the system 10 produce measurable amounts of free chlorine, are safe to handle, classified as non-hazardous and are safe for long term use (vs. iodine disinfection). The tablets are stored in water resistant tubs in waterproof packaging; classified as non-hazardous, complete with MSOS and Safe Transport documentation; and have an active ingredient to NSF/ANSI Standards Active ingredient approvals for drinking water use by the US EPA and World Health Organization. Each tub of 60 tablets measures less than 8 inches by 6 inches and treats 150,000 L of water.

An important part of the system, the collapsible bladder, or tank 14, is a custom designed, closed system, collapsible storage tank. Each bladder contains custom fittings allowing for separate inlets, outlets, testing ports, drains, etc. Each bladder contains safety and isolation devices which protect the water during storage from back flow, etc. Each bladder includes a ground sheet for added protection when operating on rough surfaces. Each bladder is constructed of food grade materials.

The tank 14 is a standard 5,000 L collapsible food grade bladder including the following: food grade, cam and groove fittings: 1×2″ inlet, 1×2″ outlet, 1×2″ testing port, 1×2″ tablet port, 2×2″ drains. The footprint dimensions are approximately 13×15 feet with a full height of approximately 2 feet. Each bladder is complete with a ground sheet; and safety and isolation devices to isolate water during storage and distribution. An optional second 5,000 L collapsible bladder, duplicate of above to increases daily production (optional second bladder requires additional storage/transportation case). Optional mil-spec material is available, as is a 10,000 L bladder.

The system 10 includes a gasoline powered centrifugal pump kit with an option to upgrade to a unique diesel powered pump kit that includes an onboard electrical generator and flood light system. The system 10 includes gasoline powered pump which includes (2) pumps: one pump is dedicated to moving raw, untreated water from the water source to the filtration module while the second pump is dedicated to moving treated water from the bladder to the end user ensuring zero cross contamination. The pumps have unique fittings and labels to differentiate the raw water and treated water pumps.

The system 10 has an intake strainer with a micro-filtration cover that is a revolutionary product that will keep water flowing even when completely covered with grass, leaves etc. An additional custom flange keeps the strainer from contacting the bottom of the water source where most fouling problems can occur. The intake strainer will keep water moving under the most challenging of conditions saving valuable time associated with clearing fouled intake strainers. This strainer also provides excellent protection for the pump from damaging debris, The intake is rated to 150 gpm, has a dual layer core filtration to 1 mm, is easy to use with a replaceable micro-filtration cover filtering to less than 1,000 microns; has a detachable ground protection flange; has PVC cam lock fittings and has a 50 foot, #3 line, and safety tether with carabineer to secure the strainer to shore when in use.

There is a significant array of hoses on the market, including a wide array of quality and functionality differences. The system 10 uses specific hoses for specific purposes. Each hose is food grade rated and of the highest quality. Each hose includes different fittings and/or diameters to ensure that raw water hoses and potable water hoses are never mixed up. Each hose is also labeled with waterproof, durable labels that include the hose label and placement instructions. Each hose is pressure tested to 60 PSI. Each hose is built with durable, temperature rated, food grade polypropylene cam and groove fittings (excluding distribution hoses built with brass quick connect fittings). The base hose package included with the system contains: 1 suction hose 1″×25 feet, hard wall, suction rated; 1 supply hose, 1″×75 feet, lay flat with non-kink swivel; 1 supply hose, ¾″×50′ feet, hard wall, complete with shut off valve; 1 supply hose, 1″×50 feet, hard wall, complete with shut off valve and check valve; 1 supply hose, 1″×25 feet, lay flat with non-kink swivel, complete with shut off valve and check valve; and 4 distribution hoses, ½″×12 feet, hard wall, complete with spring loaded nozzles, without lock open device. Optional cold weather rated hoses are available as well as additional length.

The dispensing/distribution kit is designed to move treated water out of the collapsible bladder to the end user. Using the pump specified in the pumping kit, a special fitting designed to attached to the outside of the container 16 splits the flow of water coming from the bladder into 4 sub lines fitted with trigger style, spring loaded dispensing nozzles. 1 to 4 users at a time can quickly and easily distribute water from the bladder using the gas powered transfer pump at a total rate of up to 29 gpm. The distribution fitting is complete with an attachment system to connect to the container 16, along with a brass, 4 head splitter which includes individual shut off valves.

A complete spare parts kit and field repair kit is critical to the successful operation of any piece of equipment in the field, especially when operating in post disaster and/or remote environments. While the entire system is designed with durability and reliability in mind, emergencies can happen. To that end, the system 10 includes a number of spare parts and field repair kits to allow users to perform extensive repairs to portable pumps, hoses, pressure gauges, water bladders, etc.

Essential to operating any water treatment system is the ability to ensure that the water produced meets certain guidelines. The system 10 includes testing devices and methods that allow field users to measure and document pH, free chlorine, ORP, and temperature. Measuring residual levels of free chlorine and/or ORP ensures that the produced, potable water contains sufficient levels of free chlorine as suggested by the World Health Organization. Measuring pH ensures the overall condition of the water source and its compatibility with the disinfectant.

The complete field ready water quality test kit includes: a battery operated meter-pH, Temp, including buffer solution, cleaning solution; test strips (50)-free chlorine; test strips (50)-pH; a durable, zippered storage pouch; a clip board and water quality documentation reports; bladder identification tags; and optional advanced kits available including tests for ORP, including data log capability.

The system 10 is also complete with an operations manual that includes all instructions and documentation required to set up, operate, maintain and pack up the system 10. 2 copies of the manual are printed on waterproof paper, with one being located in an outside pouch and one being located in an inside pouch.

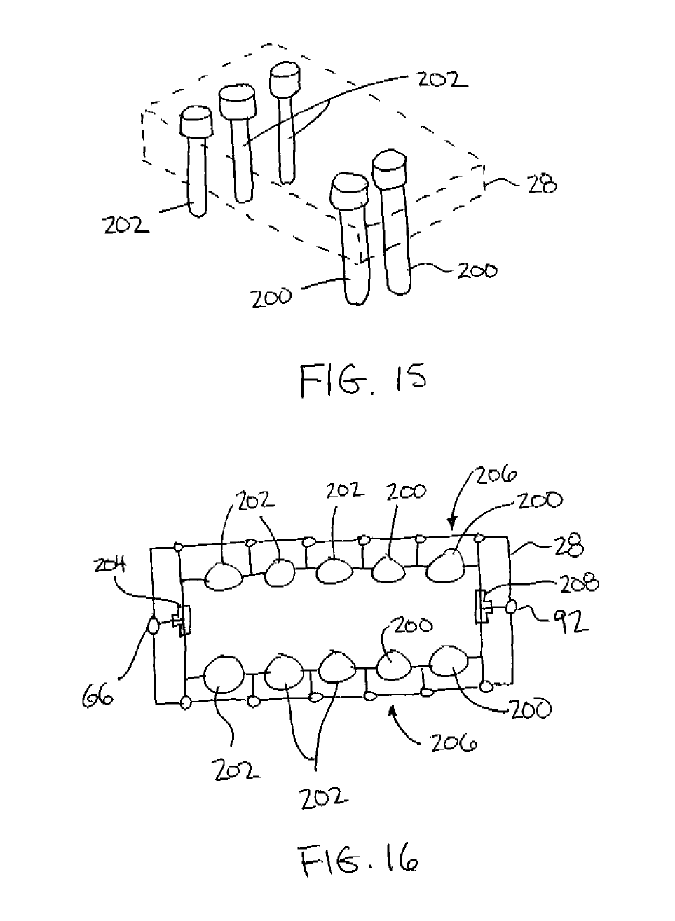

Turning now to FIG. 15, a further embodiment of the system is illustrated in which the support structure and micro-particle filtration device according to the previous embodiment are modified, however the remaining structure of the container and the features related thereto for connection to the other components of the system are substantially identical to the previous embodiments. In the embodiment of FIG. 15, the filtration device 12 comprises a combination of disposable filters 200 and reusable filters 202. The filtration device is similarly coupled from an inlet port 66 on the lid which communicates through a flow restrictor and a pressure restrictor as in the previous embodiment. The first filter is reusable and is coupled to a first pressure gauge formed in the lid, again similarly to the previous embodiment. The second and third filters are also reusable with pressure gauges mounted thereafter in the lid. After the third filter 84, the flow is directed to fourth and fifth filters in series which each comprise disposable filters. All five filters in this embodiment filter a smaller particle size than the previous filter so that the overall filtration device filters down to a particle size of approximately one micron as in the previous embodiment.

The three reusable filters are located at one end of the lid while the two disposable filters are mounted at the opposing end of the lid to define a storage area therebetween when the lid is supported above the remaining portion of the container, similarly to the previous embodiment. The remaining components of the embodiment of FIG. 15 with regard to the bladder, the intake, the interconnecting hoses, and the manner upon which the lid is supported on the container are all similar to the previous embodiment.

Turning now to the embodiment of FIG. 16, a further variation of the supporting structure mounting the filters on the lid is illustrated. In this instance the inlet port 66 in the lid communicates with an inlet manifold 204 which redirects the flow into two parallel flow paths 206. Each of the flow paths of the filtration device comprises a plurality of filters connected in series with one another before the two flow paths 206 rejoin one another at an outlet manifold 208 prior to the flow exiting the outlet port 92 of the lid. In this instance the multiple parallel flow paths 206 increase the production rate of fresh water as the flow capacity of a single filter can be overcome when two such filers are mounted in parallel.

Along each flow path 206, there is provided a combination of disposable filters 200 and reusable filters 202 with pressure gauges coupled between each adjacent pair of filters similarly to the previous embodiment. A flow meter is provided at the inlet port to indicate the overall flow rate. All of the gauges and the meter are integrally mounted into the lid for viewablity from the exterior as in the first embodiment.

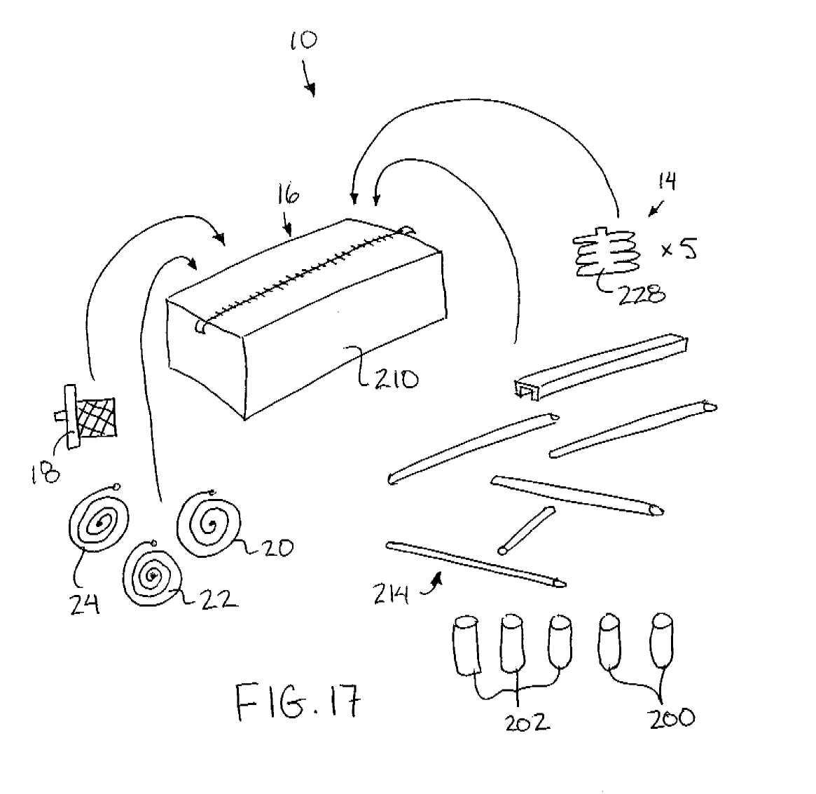

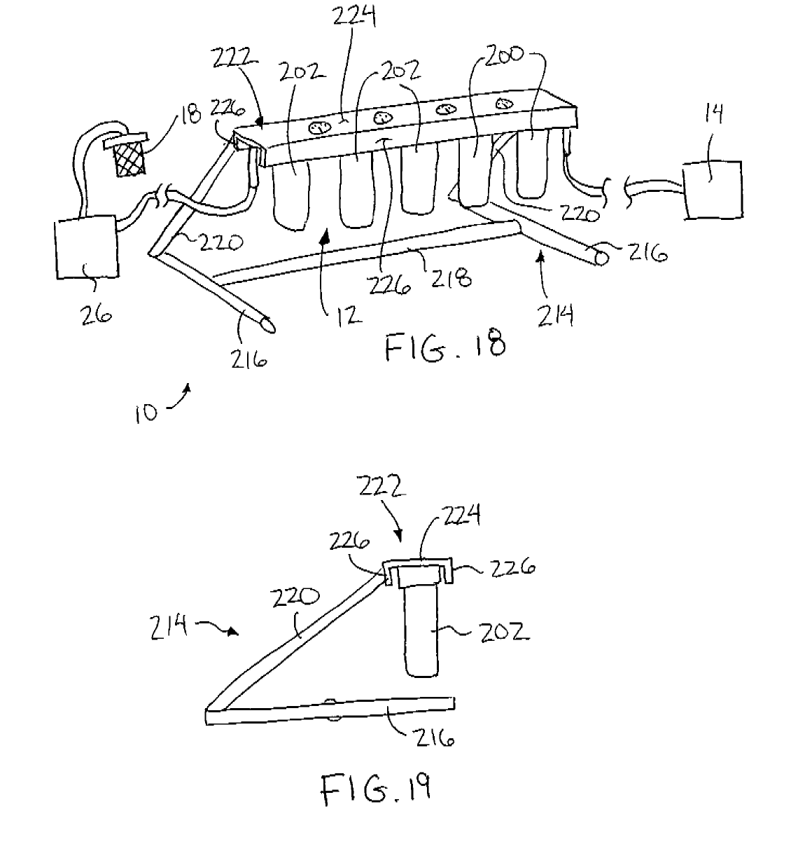

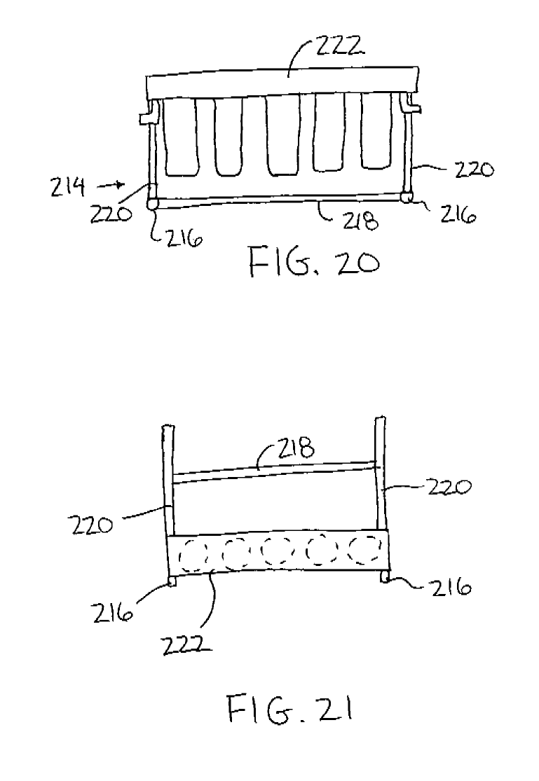

Turning now to the embodiment of FIGS. 17 through 21, a further embodiment of the system is illustrated in which the container 16 comprises a manually portable bag 210 formed of flexible walled material surrounding a hollow interior and having a seam therein forming an opening to provide access to the hollow interior. A suitable fastener, for example a zipper or snaps and the like are provided at opposing sides of the seam of the opening for selectively joining the opposing halves at the seam to close the opening in a closed position of the container in which the hollow interior is fully enclosed by the flexible walls of the bag 210. Suitable handles 212 are provided on the container so that the container may be readily carried and handled manually by a single person.

The particle filtration device in this instance is supported on the support structure 214 of the system at a location which is remote and spaced apart from the bag 210 in use. The support structure comprise a frame for suspending the filters of the filtration device therefrom in use, spaced above the ground, while the frame remains collapsible into a stored position. In the stored position of the support structure 214, the support structure is readily received in the bag 210 forming the container, along with the filters of the filtration device and the batch treatment tank in a collapsed position as well. The support structure 214 can be extended from the stored position into a usable position in which the frame members forming the supported structure are extended in relation to the stored position.

The frame of the support structure 214 generally comprises two base rails 216 which are to be supported on the ground parallel and spaced apart from one another by a cross bar 218 which is received at opposing ends within respective sockets midway along the length of the base rails 216 respectively. The cross bar 218 and the base rails are thus joined with one another in a generally H-shaped pattern. The support structure 214 further includes two uprights 220 which are mounted at respective bottom ends at respective rear ends of the base rails 216 to project upwardly and forwardly therefrom in a common vertical plane with the base rails respectively. Each upright 220 extends upwardly at an incline from the rear of the respective rail 216 to a top end of the upright which is spaced upwardly above the front end of the respective rail.

A mounting channel 222 is mounted between the top ends of the respective uprights 220 so that the mounting channel 222 spans generally horizontally spaced above the ground by a height corresponding at least to a height of the filters of the filtration device 12. The mounting channel generally comprises a base flange 224 spanning generally horizontally, and a pair of depending flanges 226 which depend downwardly from opposing elongate sides edges of the base flange 224 to form a generally U-shaped cross section of the mounting channel 222.

The mounting channel 222, the rails 216, the cross bar 218 and the uprights 220 are all connected by releasable connections using threaded fasteners or locking pins and the like.

The filtration device 12 according to this embodiment comprises a set of five filters including three reusable filters 202 and two disposable filters 200 connected in series with one another. Pressure gauges are located at the inlet and between each adjacent pair of filters in series with one another so as to be configured similarly to the embodiment of FIG. 15.

As shown in FIG. 17, the system still includes a batch treatment tank 14, an inlet hose 20, an intake 18, an outlet hose 22 and a distribution hose 24 similar to the previous embodiment for being receivable within the bag 210 in the closed position of the container. The batch treatment tank 14 in this instance may comprise either an expandable bladder which can be expanded to plural times the volume of the container in the in use position as noted above, while still remaining collapsible for being received in the container in the closed position. Alternatively the tank may be replaced with a series of collapsible bottles 228. The bottles 228 in this instance are again collapsible into a stored position receivable within the container in the closed position. The bottles 228 can be expanded to a useable position having a volume which is plural times that of the stored or collapsed position. A suitable dispensing manifold and dispensing nozzles may again be provided in this embodiment for being received in the container in the stored or closed position.

A raw water pump 26 and potable water pump 28 are similarly provided in all embodiments. The pumps may be gas powered or in some preferred embodiments may be electrically powered either by use of an on site electrical power source or portable batteries and the like.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A portable water purification system comprising:
a portable container comprising a hollow interior surrounded by walls and an opening in the walls which is operable between an open position arranged to provide access to the hollow interior through the opening and a closed position in which the hollow interior is substantially enclosed by the walls;
an intake arranged for communication with a source of water;
a micro-particle filtration device having an inlet and an outlet and being arranged for communication of the inlet with the intake for mechanically filtering the water from the source of water;
a support structure arranged to support the micro-particle filtration device thereon, the support structure being operable between a stored position in which the support structure is receivable within the hollow interior of the container and a usable position in which the support structure is extended in relation to the stored position and is arranged to suspend the filtration device therefrom;
a portable batch treatment tank for communication with the outlet of the filtration device so as to be arranged for batch chemical treatment of the mechanically filtered water from the filtration device in the batch treatment tank; and
a pump arranged to pump the water from the intake, through the particle filtration device, and into the batch treatment tank.

2. The system according to claim 1 wherein the batch treatment tank is expandable from a stored position, in which the batch treatment tank is receivable within the hollow interior of the container, to a usable position, in which the batch treatment tank has a volume which is plural times a volume of the batch treatment tank in the stored position.

3. The system according to claim 2 wherein the batch treatment tank has a volume which is plural times a volume of the container in the stored position.

4. The system according to claim 1 wherein the batch treatment tank is arranged to be supported remotely and spaced apart from the container in use.

5. The system according to claim 1 wherein the intake includes a micro filtration cover.

6. The system according to claim 1 wherein there is provided a flow restrictor coupled in series with the inlet of the filtration device which prevents flow into the filtration device above a prescribed upper flow limit of the filtration device.

7. The system according to claim 1 wherein the portable container is manually portable and includes handles formed integrally thereon for gripping with a hand of a person.

8. The system according to claim 1 wherein there is provided a distribution system including a distribution manifold, a distribution hose for connection from the batch treatment tank to the distribution manifold, and a plurality of distribution valves controlling distribution of water through the manifold, the distribution system being receivable in the hollow interior of the container when the container is in the closed position.

9. The system according to claim 1 wherein the support structure is mounted integrally on the container and suspends the filtration device therefrom for movement of the filtration device with the support structure between the stored position within the hollow interior and the usable position in which the filtration device is raised in relation to the stored position to extend through the opening.

10. The system according to claim 1 wherein the container comprises rigid walls and a lid which is movable relative to the opening for operation between the open and closed positions and wherein the support structure integrally mounts the filtration device on the lid of the container such that the filtration device is movable with the lid between the closed position of the lid, in which the support structure is in the stored position, and the open of the lid, in which the support structure is in the usable position.

11. The system according to claim 10 wherein the lid is supported spaced above the walls of the container in the open position by upright legs, the legs being collapsible and receivable within the hollow interior of the container in the closed position of the lid.

12. The system according to claim 1 wherein the container is elongate in a longitudinal direction between opposed ends and wherein the filtration device comprises a plurality of filters supported by the support structure integrally on the container at the opposing ends and defining a storage area therebetween.

13. The system according to claim 1 wherein the container comprises rigid walls and a lid which is movable relative to the opening for operation between the open and closed positions and wherein there is provided an inlet conduit for connecting the intake to the inlet of the filtration device and an outlet conduit for connecting the outlet of the filtration device to the batch treatment tank, the inlet conduit and the outlet conduit being supported to extend through the lid by respective ports integrally formed on the lid.

14. The system according to claim 13 wherein the filtration device is operable within the hollow interior of the container with the lid in the closed position.

15. The system according to claim 1 wherein there is provided at least one gauge arranged for monitoring a pressure condition of the filtration device, the gauge being integrally supported on the container and being readable from an exterior of the container.

16. The system according to claim 1 wherein:
there is provided an inlet hose for communication between the intake and the filtration device, an outlet hose for communication between the filtration device and the batch treatment tank and a distribution hose for communication from the batch treatment tank to a distribution manifold;
the filtration device comprises a plurality of filters integrally supported on the container at spaced positions defining a storage area therebetween; and
the intake, the hoses, the distribution manifold and the batch treatment tank are receivable in the storage area within the hollow interior of the container in the closed position of the lid.

17. The system according to claim 1 wherein the filtration device comprises an inlet manifold arranged for communication with the intake, an outlet manifold arranged for communication with the batch treatment tank, and a plurality of flow paths communicating between the inlet manifold and the outlet manifold in parallel with one another, each flow path comprising a plurality of filter members in series with one another.

18. The system according to claim 1 wherein the filtration device comprises at least one disposable filter member and at least one reusable filter member, the filter members being supported in series with one another.

19. The system according to claim 1 wherein the container comprises walls of flexible material arranged to support the filtration device and the support structure within the hollow interior of the container in the closed position.

20. The system according to claim 1 wherein the support structure is
arranged to support the filtration device remotely and spaced apart from the container in the usable position.
